(19) United States
(12) Patent Application Publication
(10) Pub. No.: US 2005/0202372 A1
(43) Pub. Date: Sep. 15, 2005

(54) Method and apparatus for visually differentiating between natural tooth structure and a restorative material

(76) Inventor: William T. Rapczynski, Florham Park, NJ (US)

Correspondence Address: DARBY & DARBY P.C., P. O. BOX 5257, NEW YORK, NY, 10150-5257, US

(21) Appl. No.: 10/797,469

(22) Filed: Mar. 9, 2004

(51) Int. Cl. A61C 5/00; A61C 3/00

(52) U.S. Cl. 433/215; 433/29

(57) ABSTRACT

A method for removing a failed dental restoration of a composite filling material and/or a bonding cement which under ambient light is not readily distinguishable from natural tooth structure includes the steps: applying ultraviolet light to the tooth from which the composite filling material or resin-cemented restoration is to be removed and thereby making the restorative material distinguishable from the natural tooth structure, and removing the restorative material by conventional means while observing the tooth and restorative material in the presence of the ultraviolet light.

### BACKGROUND OF THE INVENTION

The present invention relates to a method and apparatus for creating a visible contrast between natural tooth structure and a restorative material. As currently envisioned, the invention will be useful to dentists when removing old fillings of composite filling material, resin-cemented restorations such as crowns, inlays and veneers, and resin cements used for bonding of orthodontic brackets, because it solves the problem of visually distinguishing between the restorative material to be removed and the natural tooth structure to be left in place.

At present, silver amalgam is still the predominant filling material used in dentistry, but composite resin materials with various chemical formulations are rapidly replacing silver amalgam as a dental filling material. Removal of old and failed silver amalgam restorations is a relatively simple process due to the color disparity between the natural tooth structure and the silver filling material. Composite restorations, however, show no significant appearance contrast against the natural tooth structure. It is in fact extremely difficult to discern the difference visually or tactilely between composite material and natural tooth structure. The lack of visual differentiation between a composite restoration material and the natural tooth structure is of serious concern in the removal of old composite restorations and resin-cemented crowns/veneers, because it creates the risk that a certain amount of healthy tooth structure is also removed along with the composite material. However, the risk of unnecessarily removing healthy tooth structure is incompatible with a basic premise in the field of dentistry, which is the conservation of tooth structure so that teeth can be maintained for the life of the patient.

It has been observed that various restorative materials produce different degrees of fluorescence and in particular that the fluorescence of composite resin materials of the aforementioned kind is different from the fluorescence of natural tooth structure. The effect of the different degrees of fluorescence is readily observable under so-called black light (ultraviolet light). In dentistry, this has been a drawback of cosmetic restorations that fail to mimic the fluorescence of natural tooth structure, because restorations that are invisible in natural light become visible under black light.

### OBJECT OF THE INVENTION

The present invention has the object of providing a method and apparatus for providing a readily discernible visual differentiation between the natural tooth structure and a composite filling material or cement by making use of the difference between the degrees of fluorescence of composite filling materials or cements and natural tooth structure. Thus, the invention aims to turn the previously undesirable effect of black light on composite tooth restorations into a useful advantage for the dental practitioner in the safe and incremental removal of failed restorative material.

### SUMMARY OF THE INVENTION

A method is proposed for removing from a tooth of a dental patient a failed dental restoration that consists of a restorative material which in ambient room light (herein referred to as visible light) is not readily distinguishable from natural tooth structure. According to the invention, the method includes the steps of:
applying ultraviolet light to the restorative material and thereby making the restorative material distinguishable from the natural tooth structure, and
removing the restorative material by conventional means while observing the tooth and the restorative material in the presence of the ultraviolet light.

The terms “restoration” and “restorative material” as used herein refer to filling materials as well as bonding cements used for crowns, inlays, veneers, and orthodontic brackets. Typically, these materials consist of resin compositions.

Advantageous embodiments of the inventive method include the application of ultraviolet light in combination with visible light.

Such combinations of ultraviolet light and visible light include, but are not limited to:
continuous ultraviolet light combined with continuous visible light,
pulsating ultraviolet light combined with continuous visible light,
pulsating visible light combined with continuous ultraviolet light,
alternating pulses of visible and ultraviolet light.

As a preferred concept of the invention, the dentist practicing the inventive method controls the parameters of the ultraviolet light and the visible light in order to achieve the best possible contrast between the tooth structure that is to be left in place and the restorative material that is to be removed. For example, intensity, wavelength, and different modes of continuous, alternating, oscillating, pulsating and intermittent illumination with ultraviolet and visible light can be controlled through a suitable user interface such as hand-operated or foot-operated or voice-actuated controls.

A suitable apparatus to perform the method according to the invention is configured as an illumination system with a control module, a light source, and a light-projecting device that projects or focuses the ultraviolet and/or visible light on the tooth that is being treated. Particularly preferred are arrangements where the light-projecting device is integrated in or attached to the dental handpiece.

Alternatively, the light-projecting device can be incorporated in a headset, i.e., a device that is attached to the dentist's head.

In advantageous embodiments of the invention, the light-projecting device is connected to an electric light source contained in a stationary control module through a flexible light conduit such as a fiber-optic cable.

Alternatively, the ultraviolet and/or visible light can be generated by a compact electric light source that is contained directly in the light-projecting device itself, in which case the light source is powered through an electrical cable from the control module.

Suitable light sources for visible light as well as ultraviolet light include light-emitting diodes (LEDs). For example, a combination of several diodes for different wavelengths of ultraviolet and/or visible light can be operated with the aforementioned selective controls for intensity, wavelength and different modes of continuous, oscillating, pulsating, or intermittent illumination.

### BRIEF DESCRIPTION OF THE DRAWINGS

The invention is explained below with examples of preferred embodiments with reference to the attached drawings, wherein:

FIG. 1 schematically illustrates an embodiment of the apparatus according to the invention;

FIG. 2 schematically illustrates a detail variation of the apparatus of FIG. 1;

FIG. 3 represents a dental handpiece connected through a cable to a power source; and

FIG. 4 illustrates a headlamp with a cable leading to an illumination control module.

### DETAILED DESCRIPTION OF PREFERRED EMBODIMENTS

In an application of the method according to the invention, the dentist prepares for the removal of a failed dental restoration in the normal manner by:
anesthetizing the patient;
selecting the appropriate size dental burr for removing the failed restoration; and
isolating the tooth with a rubber dam or cotton roll.

The dentist then turns on the ultraviolet light and begins the removal procedure. The addition of an ultraviolet component to the illumination will cause the tooth and the filling material or cement to fluoresce in different ways, so that there is a visible contrast which allows the dentist to remove the failed restoration material confidently and precisely to the point where the natural tooth structure begins but without harming any part of the healthy natural tooth structure. As a result, the removal procedure is not only more precise but also faster, which benefits both the dentist and the patient.

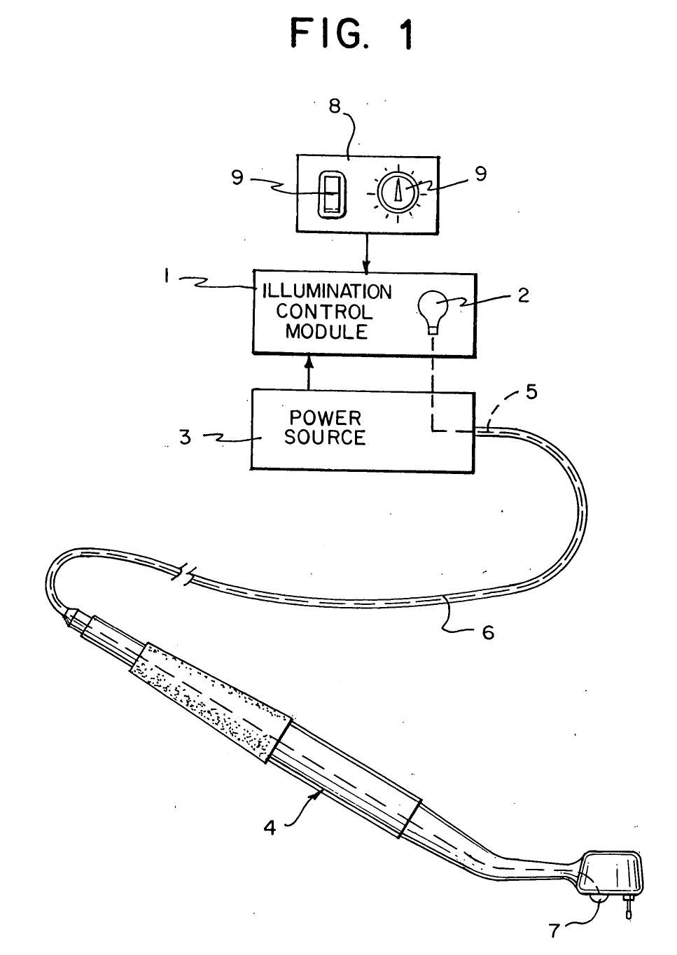

FIG. 1 schematically represents a first embodiment of an apparatus that is designed to perform the method according to the invention. An illumination control module 1 containing a light source 2 is combined with the power source 3 of a dental handpiece 4. A fiber-optic cable 5 is integrated in the power conduit 6 of the handpiece 4. Typically, the power conduit 6 carries a stream of compressed air driving the dental burr through a turbine (not illustrated) in the handpiece. The fiber-optic cable 5 ends in a light-projecting device 7 that is integrated in the handpiece 4. The illumination control unit 1 has a user interface device 8 with one or more control elements 9, e.g., a foot pedal, one or more hand-operated keys or turning knobs, a voice-responsive device, or a suitable combination of such control elements. The light generated in the light source 2, transmitted through the fiber-optic cable 5, and projected onto a patient's tooth through the light-projecting device 7 can be either ultra-violet light alone, or it can be a combination of ultra-violet light and visible light. The one or more control elements 9 serve to control the light parameters such as intensity, wavelength and different modes of continuous, oscillating, pulsating, or intermittent illumination. The light source 2 consists, e.g., of one or more light-emitting diodes including at least one that generates ultraviolet light.

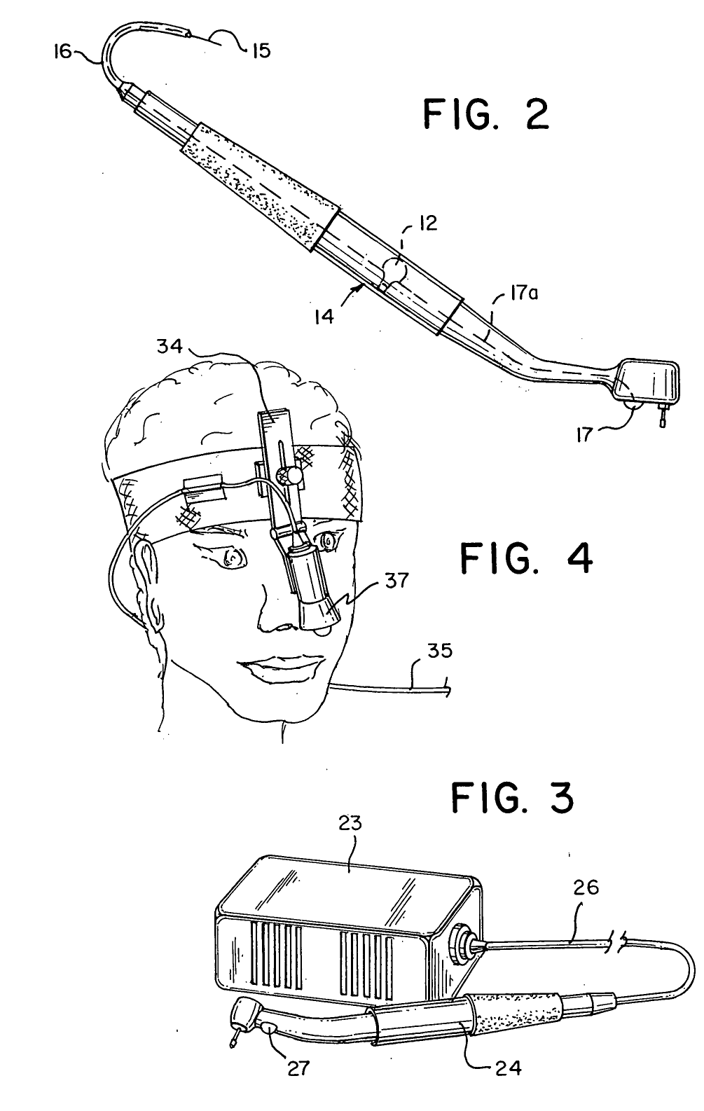

FIG. 2 represents a detail variation of the device shown in FIG. 1. In the device according to FIG. 2, the light source 12 is arranged in the handpiece 14, e.g., as an integral part of the light-projecting device 17, or connected to the light-projecting device 17 through a short light conductor 17a inside the handpiece. The light source 12 in this embodiment is connected to an illumination control unit through an electrical cable 15 integrated in the power conduit 16 of the handpiece 14. Except for the fact that the light source 12 is arranged in the handpiece, the embodiment of FIG. 2 is equivalent to the embodiment of FIG. 1.

FIG. 3 represents a perspective view of a dental handpiece 24 in accordance with FIG. 1 or FIG. 2. A light-projecting device 27 is integrated in the handpiece 24 in a suitable location to project light on the tooth being treated. The handpiece 24 is connected to a power source 23 through a cable 26 which contains either a fiber-optic cable analogous to the fiber-optic cable 5 of FIG. 1 or an electrical connection analogous to the electrical cable 15 of FIG. 2.

FIG. 4 illustrates an embodiment of a light-projecting device 37 that is integrated in a headset 34 that is worn by the dentist. The light-projecting device 37 in the headset of FIG. 4 is of an analogous configuration as the light-projecting devices in the preceding embodiments, i.e., the light source can be arranged in an illumination control module and connected to the light-projecting device through a light conductor such as a fiber-optic cable 35, or the light source can be incorporated in the light-projecting device itself and powered from the illumination control module through an electrical cable.

The light source in the headlamp of FIG. 4 can generate ultraviolet light or visible light or both. The headlamp can also work in combination with a light source in the dentists handpiece, where the headlamp generates visible light while the handpiece projects ultraviolet light at the tooth or vice versa.

1. A method for removing from a tooth of a dental patient a dental restoration of a material which in ambient light is not readily distinguishable from natural tooth structure, said method comprising the steps of:
applying ultraviolet light to the restorative material and thereby creating a visible contrast between the restorative material and the natural tooth structure, and
removing the restorative material by conventional means while observing the tooth and restorative material in the presence of the ultraviolet light.

2. The method of claim 1, wherein the dental restoration comprises a filling and the restorative material comprises a composite filling material.

3. The method of claim 1, wherein the dental restoration comprises one of a resin-cemented crown, a resin-cemented inlay, a resin-cemented veneer, and a resin-cemented bracket, and wherein the restorative material comprises a bonding cement.

4. The method of claim 1, wherein the ultraviolet light is applied in combination with visible light.

5. The method of claim 4, wherein said combination comprises continuous ultraviolet light applied simultaneously with continuous visible light.

6. The method of claim 4, wherein said combination comprises pulsating ultraviolet light applied simultaneously with continuous visible light.

7. The method of claim 4, wherein said combination comprises continuous ultraviolet light applied simultaneously with pulsating visible light.

8. The method of claim 4, wherein said combination comprises alternating pulses of ultraviolet light and visible light.

9. The method of claim 4, further comprising the step of controlling at least one characteristic parameter of at least one of the ultraviolet light and the visible light in order to optimize said visible contrast.

10. The method of claim 9, wherein the at least one characteristic parameter belongs to the group consisting of intensity, wavelength, pulse length, and pulse frequency.

11. The method of claim 9, wherein the step of controlling is performed by actuating a user interface from the group consisting of hand-operated controls, foot-operated controls, and voice-actuated controls.

12. An apparatus for creating a visible contrast between natural tooth structure and a restorative material, comprising an illumination system with a control module, a light source and a light-projecting device that projects light on a tooth being treated, wherein said light comprises at least an ultraviolet component.

13. The apparatus of claim 12, wherein said light comprises ultraviolet light in combination with visible light.

14. The apparatus of claim 13, wherein said combination comprises at least one of:
continuous ultraviolet light combined with continuous visible light,
pulsating ultraviolet light combined with continuous visible light,
pulsating visible light combined with continuous ultraviolet light, and
alternating pulses of visible and ultraviolet light.

15. The apparatus of claim 12, wherein the light-projecting device is part of a dental handpiece.

16. The apparatus of claim 12, wherein the light-projecting device is part of a headset.

17. The apparatus of claim 12, wherein the light source is arranged in the control module and the light is transmitted from the light source to the light-projecting device through a flexible light conduit.

18. The apparatus of claim 12, wherein the light source is arranged in the light-projecting device, and the light source is powered from the control module through an electrical cable.

19. The apparatus of claim 12, wherein the light source comprises at least one light-emitting diode.

20. The apparatus of claim 19, wherein the at least one light-emitting diode emits ultraviolet light.

21. The apparatus of claim 12, wherein the control module has a user interface from the group that consists of a manually operated control, a foot-operated control, and a voice control.

22. The apparatus of claim 21, wherein the user interface is operative to control at least one characteristic parameter of the light selected from the group of parameters consisting of intensity, wavelength, pulse length, and pulse frequency.

23. The apparatus of claim 15, wherein the illumination system comprises in combination with the light-projecting device in the handpiece a further light-projecting device that is part of a headset.
